(19) United States
(12) Patent Application Publication
(10) Pub. No.: US 2015/0142503 A1
(43) Pub. Date: May 21, 2015

(54) METHOD AND COMPUTER PROGRAM PRODUCT FOR WORKFLOW MANAGEMENT

(71) Applicant: Agfa HealthCare NV, Mortsel (BE)

(72) Inventors: Nadia De Paepe, Mortsel (BE); Marc Coomans, Mortsel (BE); Wannes Kieckens, Mortsel (BE); Caroline Bogaert, Mortsel (BE)

(21) Appl. No.: 14/400,867

(22) PCT Filed: May 30, 2013
(86) PCT No.: PCT/EP2013/061150

§ 371 Date: Nov. 13, 2014

Related U.S. Application Data
(60) Provisional application No. 61/659,990, filed on Jun. 15, 2012.

(30) Foreign Application Priority Data
May 30, 2012 (EP) 12169914.4

(51) Int. Cl. G06Q 10/06

(52) U.S. Cl. CPC G06Q 10/06316
USPC 705/7.26

(57) ABSTRACT

In a desktop for workflow management, a global task list of tasks to be performed is generated. The global task list includes a sequence of plural individual task lists ordered according to a configurable task list order. Each individual task list contains one or more tasks ordered according to respective individual task list sort criteria, and each individual task list is updated automatically through a notification mechanism. For each individual task list in the global task list, respective tasks that form part of the individual task list are listed in the global task list in order of appearance in the individual task list.

### CROSS-REFERENCE TO RELATED APPLICATIONS

This application is a 371 National Stage Application of PCT/EP2013/061150, filed May 30, 2013. This application claims the benefit of U.S. Provisional Application No. 61/659,990, filed Jun. 15, 2012, which is incorporated by reference herein in its entirety. In addition, this application claims the benefit of European Application No. 12169914.4, filed May 30, 2012, which is also incorporated by reference herein in its entirety.

### BACKGROUND OF THE INVENTION

1. Field of the Invention

The present invention generally relates to workflow management, i.e. management of the different tasks to be performed by an individual or a team of individuals. Workflow management is important for instance in medical applications such as radiology, where for example a technician makes medical images of a patient (e.g. an x-ray scan, a CT scan, an MRI scan, an ultrasound scan, etc.), a radiologist interprets the medical images, a transcriptionist produces a report reflecting the radiologists' interpretation, and a clinician receives the report and advises the patient. The individuals involved in the entire workflow may be working at a single facility (e.g. a hospital or imaging centre) or may be working at different locations (e.g. a hospital or enterprise with multiple facilities). In order to govern the different tasks to be performed, a workflow management tool will be deployed and made accessible to the involved individuals at different locations. The current invention in particular concerns a method and tool for workflow management that is more user-friendly, requires less interaction from the user, improves the user's visibility on the outstanding tasks, and consequently is less prone to human errors.

2. Description of the Related Art

The article “From Shared Data to Sharing Workflow: Merging PACS and Teleradiology” from the authors Menashe Benjamin, Yinon Aradi and Reuven Schreiber, published in the European Journal of Radiology 73 (2010) 3-9, describes a system combining storage of medical images and workflow management for radiology. The radiologists or other users of the system may be working on-site or remotely. In order to increase the radiologist's efficiency, the known system produces individual worklists per site, and also a global worklist wherein the tasks of the individual worklists per site are combined for the radiologist. In order to produce such global list, the local site databases have to send their data and metadata in a synchronized fashion to a central data center from which the global worklist will be produced and redistributed to the different sites.

Such global worklist that results from querying a central database that is updated in a synchronized way with data from local databases, will not be an exact merge of the individual worklists. At a particular point in time, the list of tasks in the global worklist shall most of the times differ from the combined tasks listed in the individual worklists. This is due to the fact that the global task list and the individual task lists are based on queries that run at different time instances on different databases.

Further, the order wherein tasks appear in the global work list will differ from the order wherein these tasks appear in the individual worklists. This is due to the fact that the individual task lists will be ordered according to mutually different sort criteria. Even if the tasks listed in the global worklist are identical to the combined tasks listed in the individual worklists, it will not be possible to define sorting criteria for the global worklist that will enable to maintain the order of the tasks in the different individual worklists.

In summary, although the closest prior art solution known from Menashe Benjamin et al. produces a global worklist that improves management of the tasks to be performed by a radiologist at different locations, the tasks presented in the global task list may differ from those presented in the individual task lists, and the sequence of tasks in the global task list differs from the sequence of tasks in the individual task lists. As a consequence, low priority tasks may be handled before high priority tasks. Completeness of the global task list still requires consultation of the individual task lists thus requiring extra mouse clicks and human interaction that is error prone.

### SUMMARY OF THE INVENTION

Preferred embodiments of the present invention disclose a method and computer program products that overcome the above identified drawbacks of the known workflow management tools. In particular, preferred embodiments of the invention provide a method and computer program products for workflow management that enable a user to visualize a global task list that corresponds with the combined individual task lists, and that reflects the sequence wherein these tasks have to be performed by the user. The method and computer program products according to preferred embodiments of the invention do no longer require consultation of the individual task lists, reduce the human interaction, and are less error prone.

According to preferred embodiments of the present invention, the above identified advantages and benefits are realized by the computer-implemented method of operating a data processing system to generate a desktop for workflow management in a workflow management system with client-server architecture and database, as defined below, the method comprising generating for a user a global task list of tasks to be performed, wherein generating this global task list comprises:
the user's client or server querying the database to generate plural individual task lists containing one or more tasks ordered according to respective individual task sort list criteria;
the user's client or server sequencing in computer memory the plural individual task lists according to a task list order, without querying the database, to thereby generate the global task list;
the server notifying the user's client of changes in each individual task list of the plural individual task lists to enable updates of the plural individual task lists;
the user's client listing for each individual task list in the global task list, respective tasks that form part of the individual task list in order of appearance in the individual task list;
the user's client or server updating the global task list each time an individual task list is updated as a result of a notification received; and
the user's client visualizing the global task list in a screen that is accessible for the user.

Thus, a preferred embodiment of the invention includes combining plural individual task lists between which the user is traditionally switching through mouse clicks, into a single global task list whereby the order of tasks in the individual task lists is maintained. The tasks in the global task list in other words are not merged or re-compiled through querying the database. Individual task lists are added in blocks to the global task list and the mutual sequence between all tasks is maintained. By adding the individual task lists in a predefined task list order, the global task perfectly simulates the order or logic wherein the user wishes to perform the tasks. The user has to consult only one single screen to view and manage all tasks. This significantly increases the user-friendliness and reduces the risk for human errors. Since the interaction through mouse clicks reduces significantly, workflow management becomes less error prone and the efficiency of the users in terms of an amount of tasks that can be executed per day increases. The content of the global task list is permanently in sync with the content of the individual task lists thanks to the notification mechanism. The risk to miss a task or to unduly delay the execution of a task as a result of manual switching between individual lists with different priorities and different sorting criteria, has vanished.

Thanks to the individual task lists' query and the automated notification, new tasks will automatically be added to the individual task lists and to the global task list. New tasks will automatically be added when they match the individual lists' query. Changes in the existing tasks will also be notified and induce automatic updates of the global task list. If due to the changes the task no longer matches the list query, the task is automatically removed from the individual list and the global list. As a result, the user can work with the global task list only. It is noticed that working with the global task list may involve interaction with different views or screens. All tasks may for instance be shown in a screen, named “List Area”. For execution of a task, the user may select “Start List” as a result of which a different screen, named “Text Area” may be displayed. In “Text Area”, the first task of the global list is then shown. As soon as the radiologist finalizes a task, the next task is shown in “Text Area”, based on the sorting in “List Area”. Thanks to the notifications, tasks are updated and new tasks are added in proper order to both “List Area” and “Text Area”. As a result, the radiologist can continue to work with “Text Area”.

According to an optional aspect, the computer-implemented method further comprises:
the user's client generating user interface elements enabling the user to select or unselect each individual task lists of the plural individual task lists;
the user's client displaying the user interface elements; and
the user's client respectively including or removing the individual task lists that are selected or unselected into or from the global task list.

Indeed, in a preferred embodiment of the computer-implemented method, the user can select which individual task lists have to be included in the global task list and he/she can filter out individual task lists from the global task list. Via visual indications, e.g. a check box in the main screen or menu listing the individual task lists, the user is informed which individual task lists are included and which individual task lists are excluded from the global task list.

In accordance with another optional aspect, the task list order is user configurable via a global task list configuration screen.

Hence, a configuration screen and software may be foreseen to enable the user to determine in which order the individual task lists have to be sequenced in the global task list. In case of ability to filter out individual task lists, only the individual task lists that are selected for inclusion will appear in the global task list, in the order specified through the configuration screen. The sequence of tasks within each individual list shall remain unaltered.

According to a specific embodiment of the invention, the plural individual task lists may comprise:
a high priority tasks list;
a reading tasks list; and
a sign-off tasks list,
and the task list order may by default be configured to comprise high priority tasks first, reading tasks secondly, and sign-off tasks thirdly.

In radiology for instance, a radiologist shall typically maintain in different lists high priority tasks that need to be completed by a close deadline, reading tasks like the interpretation of certain medical images as soon as these images have become available in the system, and sign-off tasks. When the high priority task list is empty, the radiologist shall start to work on the reading tasks. When both the high priority task list and the reading task list are empty, the radiologist will switch to sign-off tasks. It is noticed that tasks may appear in multiple individual lists, or dynamically move from one list to another. A reading task or sign-off task may for instance become a high priority task when the patient needs urgent treatment. Thanks to a preferred embodiment of the current invention, the high priority tasks, reading tasks and sign-off tasks will all appear in the global task list enabling the radiologist to manage his work without having to switch between the individual task lists. Since the sorting criteria of the individual lists are respected, the high priority tasks will appear in the global task list in exactly the same order as they do in the high priority task list. As a result, the radiologist will handle the high priority tasks first, and he/she will handle these tasks in the same sequence as would be imposed or suggested by the high priority list. Thereafter, the radiologist will handle the reading tasks in exactly the same order as would be imposed or suggested by the individual reading tasks list. The sorting of the individual lists shall typically be based on different criteria: whereas the high priority tasks may be sorted according to progressive study date/time, the reading tasks may for instance be sorted according to the location of the patient (ambulant vs. hospitalized). At last, the radiologist will perform the sign-off tasks in the order wherein they appear in the sign-off task list.

Obviously, the typical tasks of a radiologist are not restricted to high priority tasks, reading tasks and sign-off tasks. In practice, a radiologist shall also perform order review tasks, report review tasks, addendum tasks, etc. The above described embodiments wherein the high priority tasks list, the reading tasks list and the sign-off tasks list are integrated in the global task list, is therefore not exhaustive.

According to yet another optional aspect, the computer-implemented method may further comprise:
the user's client or server removing double entries of tasks from the global task list by maintaining for each task the first entry of a task in the global task list and deleting all further entries of the task in the global task list.

Thus, double entries of tasks may be excluded automatically from the global task list. A high priority reading task that is listed in both the high priority task list and the reading task list, will be listed only once in the global task list. In order to preserve the order wherein tasks are to be executed, the first appearance of a task in the global task list will be maintained, whereas all subsequent appearances of the task will be removed automatically.

In addition to a method defined above, a preferred embodiment of the present invention also relates to a corresponding data processing system as defined below, including computer system, a processor, or another integrated unit to carry out such computer-implemented method.

Further, the present invention also relates to a corresponding computer program as defined below, comprising software code adapted to perform such computer-implemented method.

The present invention in addition also relates to a corresponding computer readable storage medium as defined below, comprising the computer program.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 illustrates a first individual task list used by an embodiment of the method according to a preferred embodiment of the present invention;

FIG. 2 illustrates a second individual task list used by an embodiment of the method according to a preferred embodiment of the present invention;

FIG. 3 illustrates a third individual task list used by an embodiment of the method according to a preferred embodiment of the present invention; and

FIG. 4 illustrates a global task list as generated by an embodiment of the method according to a preferred embodiment of the current invention.

### DETAILED DESCRIPTION OF THE PREFERRED EMBODIMENTS

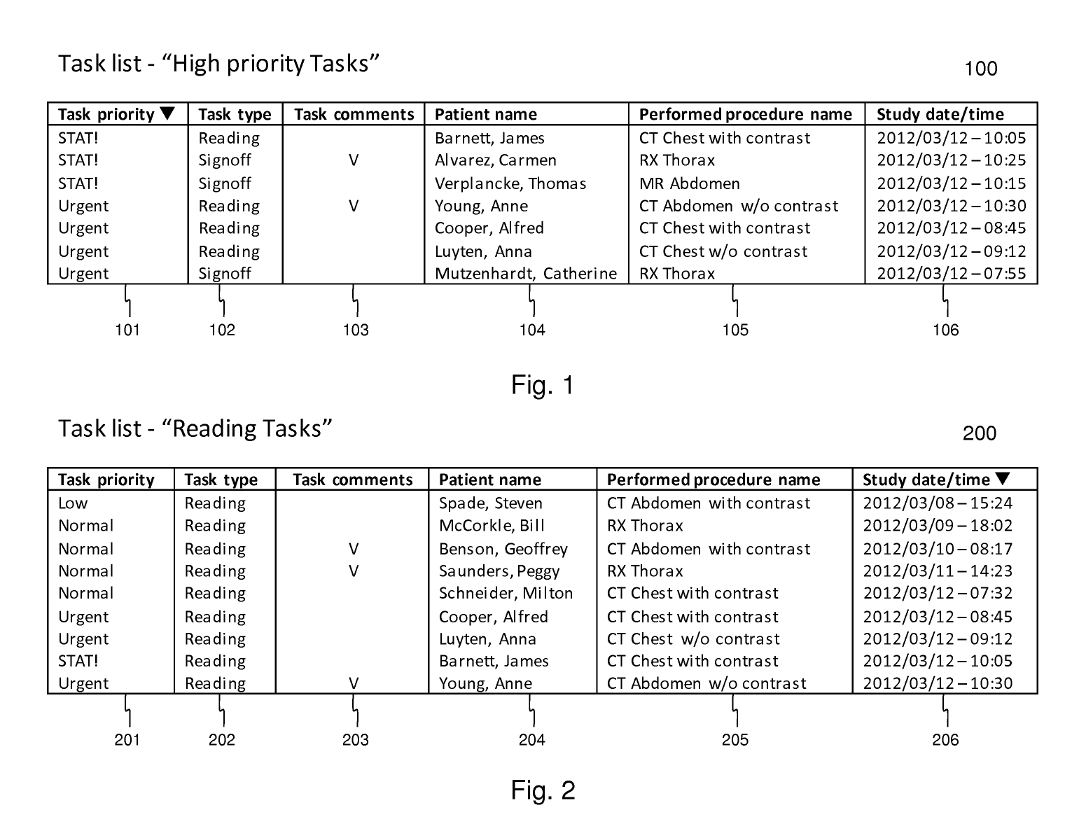

FIG. 1-4 illustrate the individual task lists and the global task list produced in a software application for workflow management in radiology. Such workflow management application typically has a client-server architecture.

The server part of the application receives queries from the client part, runs these queries on a centralized or distributed database system wherein at least the medical images, medical reports, and tasks are stored and maintained. The server part also notifies the client part in case of changes in the database system that match with one of the queries received from that client, in order to enable the client part to update and refresh the information displayed to the user.

The client part of the application enables the user to configure queries, and it generates the desktops for different types of users and the various screens according to the user's preferences and configuration settings. In the application for radiology, the desktops generated by the client part may for instance comprise a diagnostic desktop for radiologist users, a configuration desktop for administrator users, a transcriptionist desktop for the transcriptionist-user that uses the system to transfer speech recordings into text, a clinician desktop for the clinician-user that reads the medical reports from the radiologist(s) and advises the patient, a technologist desktop for the technician-user that makes the medical images. Each of these users makes use of one or more task lists accessible through his/her desktop for workflow management. Each such task list can be configured, i.e. the data fields to be displayed in a screen as part of the task list can be selected by the user, filtering criteria enabling selection of the relevant tasks for that task list are configurable by the user, and the criteria to be applied for sorting the tasks within the task list can be configured by the user. In embodiments described in the following paragraphs, a radiologist user makes use of three individual task lists configured and made accessible through his desktop. Thanks to a preferred embodiment of the current invention, the radiologist user shall also have access to a global task list that is built automatically from the individual task lists selected by the radiologist for inclusion in his global task list. The global task list does not individually query the database, but is generated from the individual task lists as will be explained in the following paragraphs.

FIG. 1 shows a first individual task list 100 of a radiologist using the application. This first individual task list is named “High priority Tasks”. This task list 100 is configured to contain six fields: Task priority 101, Task type 102, Task comments 103, Patient name 104, Performed procedure name 105 and Study date/time 106. If the task priority 101 is “STAT!” the task has the highest priority. Alternatively, the task priority 101 may be “Urgent”. The task type 102 can be either “Reading” or “Signoff”. The task comments 103 indicate if comments are available in the system with respect to that task. The patient name field 104 contains last name and first name of the patient. The performed procedure name 105 contains an indication of the type of medical imaging and the body part. The Study date/time field 106 at last shows date and time of the medical imaging. The task list 100 is further configured with specific sorting criteria. The tasks in list 100 in FIG. 1 for instance are listed in decreasing order of “Task priority”, next in decreasing order of “Task type”. The list 100 shows the high priority tasks of one user/radiologist that has logged in. The list 100 in other words is configured to select from the database only tasks that have as task priority “Urgent” or “STAT!”.

FIG. 2 shows a second individual task list 200, named “Reading Tasks” for the same user/radiologist. This task list 200 is also configured to contain six fields: Task priority 201, Task type 202, Task comments 203, Patient name 204, Performed procedure name 205 and Study date/time 206. The task priority 201 is either “STAT!”, i.e. the task has the highest priority, “Urgent”, “Normal” or “Low”. The task type 202 is always “Reading” for tasks in this list. The task comments 203 indicate if comments are available in the system with respect to that task. The patient name field 204 contains last name and first name of the patient. The performed procedure name 205 contains an indication of the type of medical imaging and the body part. The Study date/time field 206 at last shows date and time of the medical imaging. The task list 200 is also configured with specific sorting criteria. The tasks in list 200 in FIG. 2 for instance are sorted in increasing order of “Study date/time”. The list 200 shows all reading tasks of the user/radiologist that has logged in. The list 200 in other words is configured to select from the database only tasks whose task type is “Reading”.

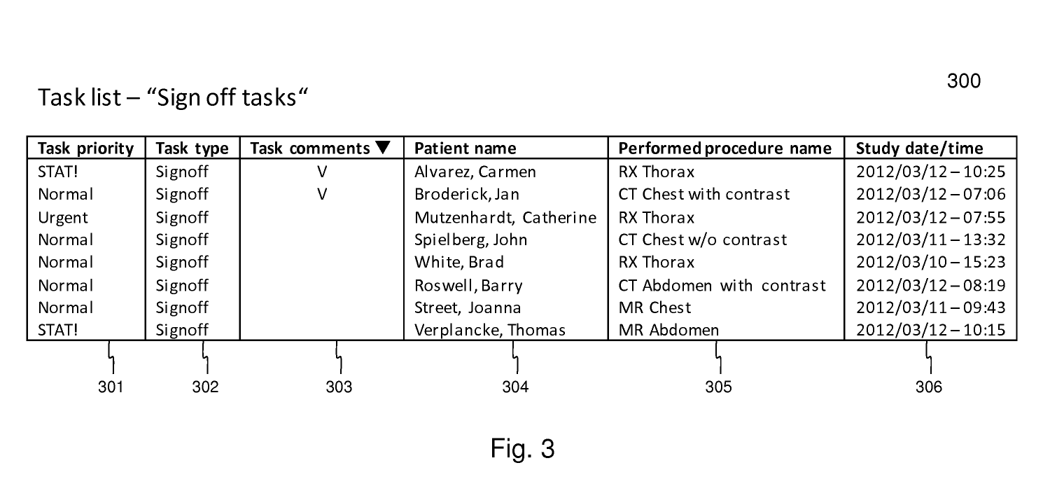

FIG. 3 shows a third individual task list 300, named “Sign off tasks” for the same user/radiologist. This task list 300 is also configured to contain six fields: Task priority 301, Task type 302, Task comments 303, Patient name 304, Performed procedure name 305 and Study date/time 306. The task priority 301 is either “STAT!”, i.e. the task has the highest priority, “Urgent”, “Normal” or “Low”. The task type 302 is always “Signoff” for tasks in this list. The task comments 303 indicate if comments are available in the system with respect to that task. The patient name field 304 contains last name and first name of the patient. The performed procedure name 305 contains an indication of the type of medical imaging and the body part. The Study date/time field 306 at last shows date and time of the medical imaging. The task list 300 is also configured with specific sorting criteria. The tasks in list 300 in FIG. 3 for instance are sorted according to presence of “Task comments”. The list 300 shows all signoff tasks of the user/radiologist that has logged in. The list 300 in other words is configured to select from the database only tasks whose task type is “Signoff”.

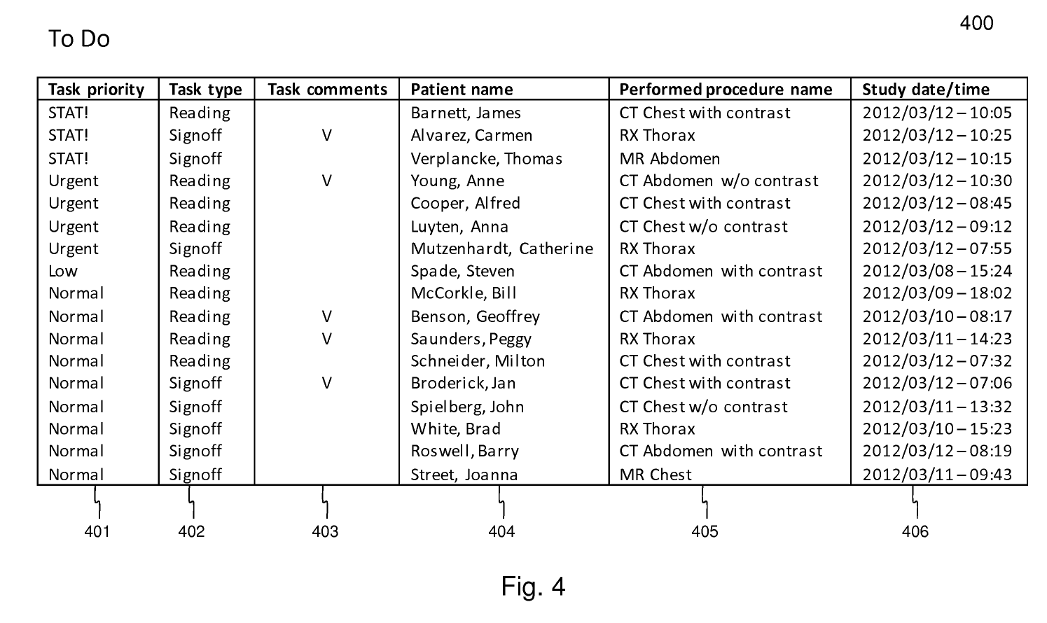

Preferred embodiments of the invention provide a smart and flexible method to improve the management of the different tasks the user/radiologist needs to perform. All tasks from the different task lists 100, 200 and 300 are automatically combined into one global task list 400 which respects a sequence of individual task lists configured by the user/radiologist, and the sequence of tasks within each individual list. This results in a specific and smart way of sorting the tasks in the global task list. The mutual sequence between all the tasks is maintained. The tasks are not merged together, but added in blocks to the global list 400 shown in FIG. 4. The global task list 400, also named the “To Do” list again contains six fields: Task priority 401, Task type 402, Task comments 403, Patient name 404, Performed procedure name 405 and Study date/time 406. First, the tasks of the “High priority Tasks” list 100 are listed in global list 400 with maintenance of the order of these tasks in list 100. Next, the tasks of the “Reading Tasks” list 200 are listed in global list 400 with maintenance of the order of these tasks in list 200 and removal of duplicates, i.e. removal of the “Urgent” and “STAT!” tasks that are already present from list 100. At last, the tasks of the “Sign off tasks” list 300 are listed in global list 400 with maintenance of the order of these tasks in list 300 and removal of duplicates, i.e. removal of the “Urgent” and “STAT!” tasks that are already present from list 100.

Summarizing, all tasks which the user/radiologist needs to perform are combined in one main task list 400, called “To do”. This global list 400 contains smaller individual task lists 100, 200 and 300. The tasks shown in the “To do” list 400 are the same tasks as within the individual task lists 100, 200 and 300. Double entries of tasks are automatically excluded in the “To do” list 400. For example, a high priority reading task which is available in both the “High priority Tasks” list 100 and the “Reading tasks” list 200 is only shown once in the “To do” list 400.

By using a checkbox in front of each individual task list, the user can indicate if the tasks from that individual task list need to be included in the “To do” list (checkbox selected) or not (checkbox not selected). If an individual task list is not selected, a visual indication will indicate that the “To do” list is filtered and which tasks are no longer included.

The sequence of the task lists within the “To do” list can be configured. The sequence of the tasks within each task list can also be configured. The default sequence of the tasks in the “To do” list can be overruled. The user/radiologist configures the sequence of the individual task lists in the global task list 400, and the sequence of the tasks within each individual list once, as a result of which all his/her tasks will be presented in the global task list 400 in the sequence needed to perform them and without extra mouse clicks.

By default, the tasks in the “To do” list 400 are sorted in the same order as their order in the individual task lists. Also the sequence of the tasks in each individual task list is preserved when building up the “To do” list 400.

The invention is flexible because the user/radiologist can easily filter out one or more individual task lists from the global task list 400. He/she can also overrule the default smart sequence of individual task lists in the global list and restore it back again.

In FIG. 4, the “To do” list 400 first shows the high priority tasks sorted in the same way as the “High priority Tasks” list 100, then the reading tasks sorted in the same way as the “Reading Tasks” list 200, and then the sign off tasks sorted in the same way as the “Sign off tasks” list 300. In case of double entries in the “To do” list 400, only the entry with the highest sequence is kept.

Moreover, based on the individual task list's queries, new tasks are automatically added to the individual task lists and the global task list 400. As a result, it is possible to keep working with the “To do” list 400 only. The individual task lists 100, 200 and 300 are updated through a notification mechanism. This notification mechanism detects changes in the central or distributed database that match with the respective queries for individual task lists 100, 200 and 300. Each time such change is detected the affected individual lists 100, 200 and/or 300 are notified and updated. The global list 400 is automatically updated when any of the individual lists where it is built from, changes.

The method according to a preferred embodiment of the invention shall typically be computer-implemented on a system or platform with client-server architecture. The medical images, reports and tasks are maintained centrally or distributed on one or more servers. Users typically access their task lists and consult images stored in the system via a client device. A data processing system or computing device that is operated according to an embodiment of the present invention can include a workstation, a server, a laptop, a desktop, a hand-held device, a mobile device, a tablet computer, or other computing device, as would be understood by those of skill in the art.

The data processing system or computing device can include a bus or network for connectivity between several components, directly or indirectly, a memory or database, one or more processors, input/output ports, a power supply, etc. One of skill in the art will appreciate that the bus or network can include one or more busses, such as an address bus, a data bus, or any combination thereof, or can include one or more network links. One of skill in the art additionally will appreciate that, depending on the intended applications and uses of a particular embodiment, multiple of these components can be implemented by a single device. Similarly, in some instances, a single component can be implemented by multiple devices.

The data processing system or computing device can include or interact with a variety of computer-readable media. For example, computer-readable media can include Random Access Memory (RAM), Read Only Memory (ROM), Electronically Erasable Programmable Read Only Memory (EEPROM), flash memory or other memory technologies, CDROM, digital versatile disks (DVD) or other optical or holographic media, magnetic cassettes, magnetic tape, magnetic disk storage or other magnetic storage devices that can be used to encode information and can be accessed by the data processing system or computing device.

The memory can include computer-storage media in the form of volatile and/or nonvolatile memory. The memory may be removable, non-removable, or any combination thereof. Exemplary hardware devices are devices such as hard drives, solid-state memory, optical-disc drives, or the like. The data processing system or computing device can include one or more processors that read data from components such as the memory, the various I/O components, etc.

The I/O ports can allow the data processing system or computing device to be logically coupled to other devices, such as I/O components. Some of the I/O components can be built into the computing device. Examples of such I/O components include a microphone, joystick, recording device, game pad, satellite dish, scanner, printer, wireless device, networking device, or the like.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfill the functions of several elements recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A computer-implemented method of operating a data processing system to generate a desktop for workflow management in a workflow management system including a client-server architecture and a database, the method comprising generating for a user a global task list of tasks to be performed including the steps of:
a user's client or server querying via the server the database to generate a plurality of individual task lists containing one or more tasks ordered according to respective individual task sort list criteria;
the user's client or the server sequencing in a computer memory the plurality of individual task lists according to a task list order, without querying the database, to generate the global task list;
the server notifying the user's client of changes in each of the plurality of individual task lists to enable updates of the plurality of individual task lists;
the user's client listing, for each of the plurality of individual task lists in the global task list, respective tasks that form a part of the respective individual task list in order of appearance in the respective individual task list;
the user's client or the server updating the global task list each time one of the plurality of individual task lists is updated as a result of a notification being received; and
the user's client visualizing the global task list in a screen that is accessible to the user.

10. The computer-implemented method according to claim 9, further comprising:
the user's client generating user interface elements enabling the user to select or unselect each of the plurality of individual task lists;
the user's client displaying the user interface elements; and
the user's client respectively including or removing each of the plurality of individual task lists that is selected or unselected into or from the global task list.

11. The computer-implemented method according to claim 9, wherein the task list order is user-configurable via a global task list configuration screen.

12. The computer-implemented method according to claim 11, wherein the plurality of individual task lists include a high priority tasks list, a reading tasks list, and a sign-off tasks list; and
the task list order by default is configured to include the high priority tasks first, the reading tasks second, and the sign-off tasks third.

13. The computer-implemented method according to claim 9, further comprising:
the user's client or the server removing double entries of tasks from the global task list by maintaining for each task a first entry of a task in the global task list and deleting all further entries of the task in the global task list.

14. A data processing system comprising a processor programmed to carry out the computer-implemented method of claim 9.

15. A non-transitory computer readable storage medium including a computer program for carrying out, when the computer program is executed on a computer, the computer-implemented method of claim 9.
